(19) United States
(12) Patent Application Publication
(10) Pub. No.: US 2004/0139210 A1
(43) Pub. Date: Jul. 15, 2004

(54) Home network system and method for operating the same

(75) Inventors: Yeon Kyung Lee, Koyang-si (KR); Ii Hoon Ji, Seoul-si (KR); Dae Sung Wang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/376,239

(22) Filed: Mar. 3, 2003

(30) Foreign Application Priority Data
Dec. 6, 2002 (KR) 2002-77502

(51) Int. Cl. G06F 15/16

(52) U.S. Cl. 709/230

(57) ABSTRACT

A home network system including a protocol converter for converting protocols such that a passive home appliance and a home server connected to a network smoothly communicate signals based on different protocols with each other and a method for operating the home network system. The protocol converter converts a status information signal based on a home appliance protocol from the passive home appliance to transmit it to the home server. The protocol converter converts a control signal based on a home server protocol from the home server to transmit it to the passive home appliance. Therefore, the home server can be compatible with the passive home appliance irrespective of manufacturer and/or protocol of the passive home appliance connected to the network. Compatibility and applicability of the home network system are thus extended and simultaneously the home network system becomes more cost-effective.

### BACKGROUND OF THE INVENTION

1. Field of the Invention

The present invention relates to a home network system having a protocol converter, and more particularly to a home network system having a home server based on a home server protocol; passive home appliances manufactured by different manufacturers and based on different protocols; and a network connected between the home server and the home appliances, wherein the home network system includes a protocol converter for operating the home server to control operations of the home appliances and converting different communication protocols of signals transmitted and received between the home server and the home appliances to monitor status information of the home appliances, and a method for operating the home network system.

2. Description of the Related Art

A configuration of a conventional home network system will be described with reference to FIG. 1.

Recently, the number of home appliance control systems for controlling a plurality of home appliances C1 to Cn coupled to a network N constructed within a home or building has greatly increased. Moreover, as the network N is coupled to an external Internet network I, the research to extend a control area of a home appliance control system is actively conducted such that a user at a remote place can remotely control the home appliances C1 to Cn located in the home or building using a terminal RC.

A home server 10 is a device for managing and controlling the home appliances C1 to Cn coupled to the network N and simultaneously monitoring operating status of the home appliances C1 to Cn. The home appliances C1 to Cn are passive home appliances for receiving control signals outputted from the home server 10 and performing operation controls in response to the control signals. The passive home appliances include electrically-driven vertical blinds, a gas-blast circuit breaker, measuring instruments, a door lock, a microwave oven, a washing machine, etc.

Accordingly, the home server 10 includes an input unit for allowing a user to input a control command to a home appliance connected to the home network N and an output unit for outputting status information of the home appliance controlled by the control command. The home server 10 can also employ a home appliance having a microcomputer capable of sufficiently processing signals transmitted to and received from the passive home appliances C1 to Cn connected to the network N. Alternatively, the home server 10 can employ a dedicated home server device. In this specification, for example, an Internet-based refrigerator acts as the home server 10, as shown in FIG. 1.

The home server 10 must sense a connection state, operation errors and results of controlled operating associated with the passive home appliances to perform central control and management. Thus, the home server 10 receives status information signals from the passive home appliances C1 to Cn to monitor them in real time. Moreover, the home server 10 displays status information of the passive home appliances C1 to Cn to the output unit such that the user can identify the status information.

Thus, the signals must be smoothly transmitted and received between the home server 10 and the passive home appliances C1 to Cn such that the home server 10 controls the passive home appliances C1 to Cn. For this reason, the home server 10 and the passive home appliances C1 to Cn must generate and output the signals based on the same protocol. However, there is a problem in that a protocol (home server protocol) used in a network provider or a manufacturer of a home server appliance is different from communication protocols (home appliance protocols) adopted in the home appliances C1 to Cn connected to the network N in the conventional home network system.

Thus, the user of the network N must purchase a passive home appliance based on the same protocol as the home server protocol. In this case, there is another problem in that purchase cost is increased and a purchase range is limited. Furthermore, home appliances based on different protocols cannot be connected to the network N and hence compatibility and applicability of the home network system are degraded.

A UPnP (Universal Plug and Play) protocol among protocols for the home network system has been developed by Intel, 3COM, Dell, IBM, Ericsson, Nokia, Philips, LG, Samsung, etc. and is used as a standard protocol of the home server appliance 10. Although an existing home appliance or a home appliance adopting a protocol different from the UPnP protocol is connected to the network N, it cannot appropriately transmit and receive signals to and from the home server 10 and hence cannot be controlled by the home server 10. Despite a user having purchased a home appliance having a home networking function, resources are wasted where the home appliance is not compatible with the home server 10.

### SUMMARY OF THE INVENTION

Therefore, the present invention has been made in view of the above problems, and it is an object of the present invention to provide a home network system including a protocol converter for converting different protocols of signals such that the signals can be appropriately transmitted and received between a home server and home appliances based on various protocols when the home appliances are connected to a network, and a method for operating the home network system, thereby improving the compatibility of home networking between the home server and passive home appliances adopting the different protocols and allowing a user to efficiently and conveniently use the home network system.

In accordance with one aspect of the present invention, the above and other objects can be accomplished by the provision of a home network system, comprising: a home server for outputting a control signal based on a home server protocol to control an operation of a home appliance connected to a network constructed for home networking; a passive home appliance for performing a control operation in response to a control signal based on a home appliance protocol and outputting a status information signal to the home server; and a protocol converter for converting different protocols of signals transmitted and received between the home server and the passive home appliance.

In accordance with another aspect of the present invention, there is provided a method for operating a home network system, comprising the steps of: a) allowing a home server to output a control signal to a passive home appliance connected to a network in response to a control command inputted by a user; b) converting a protocol of the control signal outputted at the step a) and transmitting the control signal based on the converted protocol to the passive home appliance; c) allowing the passive home appliance to perform an operation in response to the control signal transmitted at the step b) and output a status information signal; and d) converting a protocol of the status information signal outputted at the step c) and transmitting the status information based on the converted protocol.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conventional home network system;

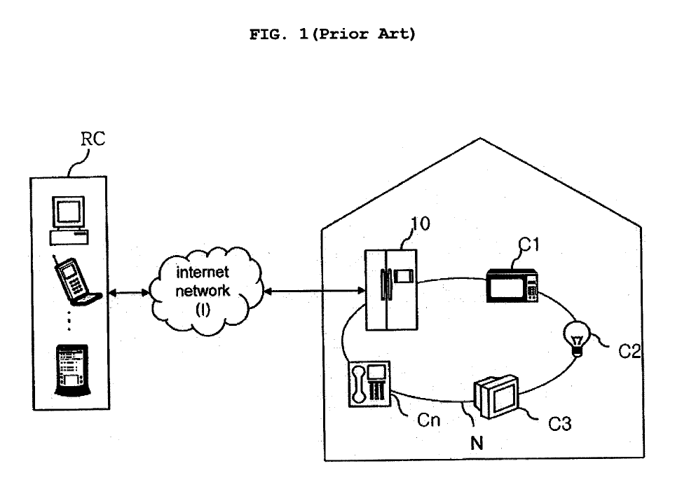

FIG. 2 is a view illustrating a first configuration of a home network system in accordance with the present invention;

FIG. 3 is a view illustrating a second configuration of a home network system in accordance with the present invention; and

FIG. 4 is a flow chart illustrating a method for operating the home network system in accordance with the present invention.

### DESCRIPTION OF THE PREFERRED EMBODIMENTS

Now, preferred embodiments of the present invention will be described in detail with reference to the annexed drawings.

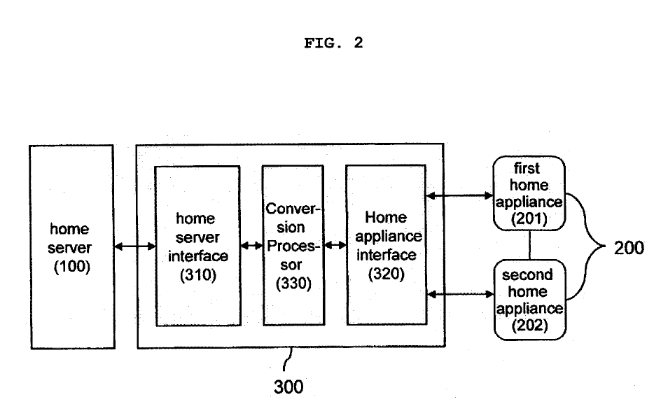

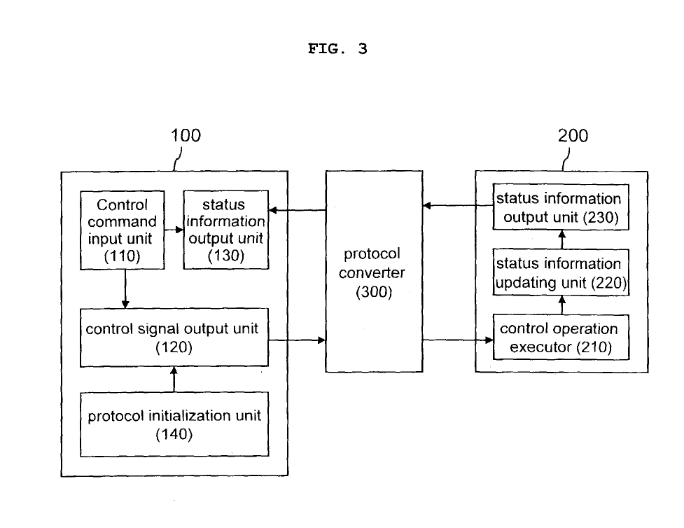

A first configuration of a home network system of the present invention includes detailed configurations of a protocol converter 300, as shown in FIG. 2. A second configuration of a home network system of the present invention includes detailed configurations of a home server 100 and passive home appliances 200, as shown in FIG. 3.

Various protocols are basically applied to the home network system. The home network system includes the passive home appliances 200 for passively performing control operations in response to control signals from the home server 100; and the home server 100 for outputting the control signals based on a home server protocol in order to monitor the status of the passive home appliances 200 and input control commands for controlling the passive home appliances 200. The home network system further includes the protocol converter 300 for converting the different protocols of the signals such that the signals can be appropriately transmitted and received between the home server 100 and the passive home appliances 200.

It is assumed that the home server 100 is based on a UPnP (Universal Plug and Play) protocol as an international standard protocol for the home network as described in “Description of the Related Art”, and the passive home appliances 200 are manufactured by different manufacturers and based on different protocols. Thus, signals outputted from the home appliances connected to the network are based on a variety of protocols.

The home server 100 receives status information signals from the passive home appliances 200 connected to the network and externally displays the received status information. A control program implemented as a user interface is driven in the home server 100 by a user. The user can monitor current connection status of the passive home appliances 200 connected to the network as well as results of control operations.

The protocol converter 300 is implemented as a module embedded in the home server 100. Alternatively, the protocol converter 300 is connected to an external terminal of the home server 100. At this time, as the protocol converter 300 is connected as an independent device between the home server 100 and the network, it can convert the protocols of the signals transmitted to and received from the home server 100 into a home server protocol. The protocol converter 300 is controlled by the home server 100 managing processing of the signals transmitted and received through the network.

The protocol converter 300 receives control signals from the home server 100 and then transmits the received control signals to a conversion processor 330. The conversion processor 330 converts the received control signals into home server protocol signals and then a home server interface 310 transmits the home server protocol signals to the home server 100. A home appliance interface 320 receives status information signals from the passive home appliances 200 and then transmits the status information signals to the conversion processor 330. Moreover, the home appliance interface 320 transmits home appliance protocol signals from the conversion processor 330 to the passive home appliances 200. The conversion processor 330 converts and processes the various protocols of signals inputted into the home server interface 310 and the home appliance interface 320, and then relays the converted and processed signals between the home server 100 and the passive home appliances 200.

A protocol applied to each of the passive home appliances 200 connected to the network can vary according to each manufacturer of a home appliance. A protocol applied to a first passive home appliance 201 is referred to as a first protocol and a protocol applied to a second passive home appliance 202 is referred to as a second protocol. The home server 100 outputs a control signal based on a home server protocol to the protocol converter 300 so as to communicate with the first passive home appliance 201. The protocol converter 300 converts the control signal based on the home server protocol into a first protocol control signal and then transmits the first protocol control signal to the first passive home appliance 201.

The first passive home appliance 201 performs a control operation in response to the first protocol control signal, generates a status information signal containing performance results and outputs the status information signal to the home server 100. The status information signal, based on the first protocol outputted from the first passive home appliance 201, is converted on the basis of a home server protocol by the protocol converter 300. The status information signal based on the home server protocol is transmitted to the home server 100. In response to the status information signal based on the home server protocol, the home server 100 outputs the status information of the first passive home appliance 201 to the user such that the user can identify the status of the first passive home appliance 201.

The home server 100 and the passive home appliances 200 will be described in detail with reference to FIG. 3. The home server 100 includes a control command input unit 110 for receiving control commands such that operations of the passive home appliances 200 connected to the network can be controlled; a control signal output unit 120 for generating control signals in response to the received control command and outputting each of the control signals to a corresponding passive home appliance 200; and a status information output unit 130 for receiving an updated status information signal, when the status of the passive home appliance connected to the network is changed, and externally outputting the updated status information.

Moreover, the home server 100 further includes a protocol initialization unit 140 for outputting a control signal to command the first passive home appliance 201 and the protocol converter 300 to perform protocol initialization after the home server 100 has successfully completed communicating with the passive home appliance 200. That is, the protocol initialization unit 140 commands the protocol converter 300 to perform the protocol initialization such that protocol conversion can be appropriately performed in response to a connection request from the second home appliance 202 based on the second protocol different from the first protocol. Thus, even though the home server 100 communicates with the second passive home appliance 202 immediately after the home server 100 has completed communicating with the first passive home appliance 201, an error in the protocol conversion is not generated because the protocol converter 300 is initialized.

The passive home appliance 200 includes a control operation executor 210 for executing a control operation in response to an inputted control command; a status information updating unit 220 for updating status information of the passive home appliance 200 according to the change of either connection status, operating status, power supply status, etc.; and a status information output unit 230 for outputting a signal of the updated status information from the status information updating unit 220 to the home server 100 so as to notify the home server 100 of the status change of the passive home appliance 200.

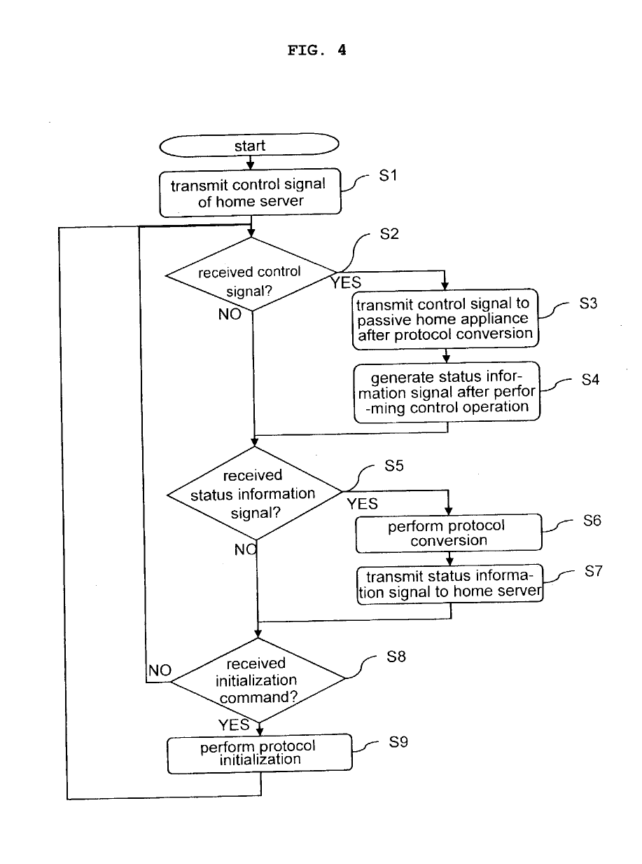

FIG. 4 is a flow chart illustrating a method for operating the home network system of the present invention configured as described above.

First, at step S1, the user of the home network system operates the home server and inputs a control command into a corresponding passive home appliance to be controlled, and then the home server generates a control signal to transmit the control command to the corresponding home appliance. At this time, the protocol converter connected to the home server determines not only whether a signal is received from the home server, but also whether a signal of status information updated according to status changes of the passive home appliances connected to the network is received.

If the protocol converter receives the control signal at the above step S2, it converts the control signal based on a home server protocol into a control signal based on a home appliance protocol and then transmits the control signal based on the home appliance protocol at step S3.

The passive home appliance performs a control operation in response to the control signal and generates a status information signal having a result of the control operation to transmit the status information signal to the home server at step S4.

Where the home server senses status change of the passive home appliance, the home server directs the protocol converter to receive the status information signal from the passive home appliance. Where the protocol converter receives the status information signal from the passive home appliance at the time of the status change of the passive home appliance at step S5, the protocol converter converts the status information signal based on the home appliance protocol into a status information signal based on the home server protocol at step S6. The protocol converter transmits the status information signal based on the home server protocol to the home server at step S7.

Where the home server outputs a control signal to command the protocol converter and the passive home appliance to perform protocol initialization after the home server has completed communicating with the passive home appliance at step S8, the protocol converter and the passive home appliance receiving the protocol initialization command perform the protocol initialization at step S9. The protocol converter then waits for a control signal so that the home server can communicate with another passive home appliance.

As apparent from the above description, the present invention provides a home network system and a method for operating the same, which enable a protocol converter to convert protocols of signals transmitted and received between a home server and passive home appliances such that the passive home appliances adopting protocols different from a communication protocol of a home server appliance are connected to a network to perform a home networking function, thereby extending the compatibility and applicability of the home network system and efficiently utilizing resources by using existing home appliances as they are.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A home network system, comprising:
a home server for outputting a control signal based on a home server protocol to control an operation of a home appliance connected to a network constructed for home networking;
a passive home appliance for performing a control operation in response to a control signal based on a home appliance protocol and outputting a status information signal to the home server; and
a protocol converter for converting different protocols of signals transmitted and received between the home server and the passive home appliance.

2. The home network system as set forth in claim 1, wherein the protocol converter is implemented as a module configured either inside or outside the home server.

3. The home network system as set forth in claim 1, wherein the protocol converter comprises:
a home server interface for transmitting and receiving a signal based on the home server protocol to and from the home server;
a home appliance interface for transmitting and receiving a signal based on the home appliance protocol to and from the passive home appliance; and
a conversion processor for converting the protocols of the signals transmitted and received between the home server and the passive home appliance.

4. The home network system as set forth in claim 1, wherein the home server comprises:
a control command input unit for receiving a control command to control the operation of the home appliance connected to the network;
a control signal output unit for generating a control signal in response to the received control command from the control command input unit and outputting the control signal to the passive home appliance; and
a status information output unit for receiving the status information from the passive home appliance connected to the network and externally outputting the status information.

5. The home network system as set forth in claim 4, wherein the home server further comprises:
a protocol initialization unit for outputting a control signal to the passive home appliance and the protocol converter so as to command the passive home appliance and the protocol converter to perform protocol initialization after the home server has completed communicating with the passive home appliance.

6. The home network system as set forth in claim 1, wherein the passive home appliance comprises:
a control operation executor for executing a control operation in response to an inputted control command;
a status information updating unit for updating status information when operating status of the passive home appliance is changed; and
a status information output unit for outputting the updated status information from the status information updating unit to the home server and notifying the home server of the status change.

7. A method for operating a home network system, comprising the steps of:
a) allowing a home server to output a control signal to a passive home appliance connected to a network in response to a control command inputted by a user;
b) converting a protocol of the control signal outputted at the step a) and transmitting the control signal based on the converted protocol to the passive home appliance;
c) allowing the passive home appliance to perform an operation in response to the control signal transmitted at the step b) and output a status information signal; and
d) converting a protocol of the status information signal outputted at the step c) and transmitting the status information based on the converted protocol.

8. The method as set forth in claim 7, wherein the step d) further comprises the step of:
performing protocol initialization after the home server has completed communicating with the passive home appliance.
